(19) United States
(12) Patent Application Publication
(10) Pub. No.: US 2009/0151001 A1
(43) Pub. Date: Jun. 11, 2009

(54) METHOD AND APPARATUS FOR OPERATING RIGHTS

(76) Inventors: Yimin Li, Shenzhen (CN); Renzhou Zhang, Shenzhen (CN); Guoxin Shi, Shenzhen (CN); Pei Dang, Shenzhen (CN); Wenjie Feng, Shenzhen (CN); Chen Zhou, Shenzhen (CN); Haojun Zhou, Shenzhen (CN)

Correspondence Address: BRINKS HOFER GILSON & LIONE, P.O. BOX 10395, CHICAGO, IL, 60610, US

(21) Appl. No.: 12/342,695

(22) Filed: Dec. 23, 2008

(30) Foreign Application Priority Data
Jun. 26, 2006 (CN) 200610091598.5
Jun. 12, 2007 (CN) PCT/CN2007/001852

(51) Int. Cl. G06F 21/00

(52) U.S. Cl. 726/26

(57) ABSTRACT

A method for operating a Right For Contents (R4C) includes: obtaining, by a terminal, a hybrid RO generated by the RI server, with the R4C items and the operation Rights For Rights (R4Rs) carried in the hybrid RO; operating the R4C items in the hybrid RO according to the R4R. A method for adding an R4R includes: a terminal receives a hybrid RO that includes the existing rights of the terminal and the newly added R4R; the terminal operates the R4C in the hybrid RO according to the new R4R. The present invention also discloses a terminal and a server. The present invention enables the RI to control the rights at a finer granularity, intensifies the RI's control on the rights, and provides a mechanism of purchasing an R4R after an RO is purchased.

### RELATED APPLICATIONS

This application claims priority to Chinese Patent Application No. 200610091598.5, filed with the Chinese Patent Office on Jun. 12, 2007 and entitled “METHOD AND APPARATUS FOR OPERATING RIGHTS,” the contents of which are hereby incorporated by reference in their entirety.

### FIELD OF THE INVENTION

The present disclosure relates to the Digital Rights Management (DRM) technology, especially, to a method and an apparatus for operating rights.

### BACKGROUND

The DRM technology prevents users from illegally copying and moving digital media contents through the network and computer, and is one of the prerequisites of selling media contents through the network. The basic principles of the DRM technology are: the Content Issuer (CI) uploads the encrypted digital media contents to the network server for being downloaded by the users, and submits the decryption key and use rights of the media contents to the Right Issuer (RI) for managing. The RI writes the information such as key and usage rights into the operation control information (for example, Right Object (RO), which is a form of operation control information). In order to use the media contents, the user not only needs to download the encrypted media content (in DRM Content Format (DCF)) from the CI server, but also needs to purchase the RO associated with the encrypted media content from the RI. In this way, the DRM Agent module on the terminal will be able to read the Content Encrypt Key (CEK) in the RO to decrypt the encrypted media content, and control the use of the media content by the user according to the usage rights described in the RO.

However, in the process of consuming media contents, the consumers are especially interested in some activities such as sharing, gifting and propagating media contents. In the aforementioned model, content media are protected with encryption, such activities are hence converted to the activities of the consumers sharing, gifting and propagating the Right for the media contents. Therefore, the consumers need to be capable of operating the rights itself.

A common solution is to provide a method that enables the issuer to control the operation rights of the consumer, for example, control the number of times of moving a right; and the consumer can only operate the rights within the control limit. For example, the conventional art provides a function of exporting an RO, but cannot clarify the details of the exported object, which tends to cause confusion or is unable to meet the individualized requirements. In the conventional art, the <export> element in the RO is designed to perform exporting. This element provides only the exporting mode (copying or moving) and the target DRM system for exporting, and does not clarify the details of the exported object (for example, whether the exported object contains the current consumption status of the right), which tends to cause confusion and undesired disputes in the commercial implementation. Suppose that an RO contains a right of playing a content for 10 times and an exporting right, after the user plays the content twice, the user exports the content. Consequently, the export result can be understood in two ways: the export result contains a right of playing the content for eight times, or the export result contains a right of playing the content for 10 times. That is because: the <export> element is not self-explanatory, and cannot clarify the details of the exported object (namely, cannot clarify whether the exported object is the combination of the original right and the current consumption status, or is the original right only). Although the conventional art clarifies the details in the technical document (that the exported object does not include the current consumption status), it is easy to cause trouble of understanding in the commercial application. Moreover, the conventional art is unable to meet individualized requirements. Some RIs or consumers require the exported object with the current consumption status, which is unavailable from the conventional art.

The applicants note that the conventional art makes the consumers have to operate an RO as a whole, and it is impossible for the consumers to operate over a specific right item in the RO. The reason are: (i) the right description language (REL) about rights in the conventional art, for example, the control information of copying in the conventional art does not describe the specific right item, but describes the whole RO by default; and (ii) nor does the REL have any measure to identify every right item itself; therefore, it is technically unsupported to operate over a specific right item and control such an operation by the rights issuer. Moreover, the conventional art is unable to control the devices involved in the right operation. If the right operation is copying, moving or exporting, the conventional art is unable to specify the attributes such as type of the target device.

Furthermore, the inventor finds that the conventional art does not provide the mechanism of adding the right for operating over the right items in an RO after purchase of the RO. This means that the consumer has to decide whether she/he will need to operate (and further more how to operate) over the right items in an RO at the time of purchasing the RO. Otherwise, the obtained RO enables no operation over any right item in the RO except reading.

### SUMMARY

The present disclosure provides a method and an apparatus for operating rights so that a terminal can operate over a right item and add a right for such operation.

The present disclosure provides a method for operating over a Right For Contents (R4C), including:
obtaining, by a terminal, a hybrid RO generated by the RI server, with the R4C items and the operation Rights For Rights (R4Rs) carried in the hybrid RO; and
operating the R4C items in the hybrid RO according to the R4R.

The present disclosure further provides a method for adding an R4R, including:
obtaining, by an RI server, the existing RO of the terminal, with the RO containing an R4C;
generating R4R information which indicates that the terminal is entitled to operate an R4C; and
sending the R4R information to the terminal.

The present disclosure further provides a method for adding an R4R includes:
receiving, by a terminal, a Right Object for Rights (RO4R) from the RI server, with the R4R item carried in the RO; and
operating the R4C according to the R4R item.

The present disclosure still further provides a method for adding an R4R includes:
receiving, by a terminal, a hybrid RO from the RI server, with the hybrid RO carrying the existing right of the terminal and a newly added R4R;
substituting, by the terminal, the received hybrid RO for the existing RO; and
operating the R4C in the hybrid RO according to the new R4R.

The present disclosure provides a terminal, including:
a module for obtaining a hybrid RO generated by the RI server, wherein the hybrid RO contains R4C items and R4Rs; and
a module for operating an R4C item in the hybrid RO according to the R4R.

The present disclosure further provides a server, including:
a module for obtaining the existing RO of the terminal, with an R4C carried in the RO;
a module for generating the R4R information which indicates that the terminal is entitled to operate the R4C; and
a module for sending the R4R information to the terminal.

The present disclosure further provides another terminal, including:
a module for receiving an RO4R from the RI server, with the R4R item carried in the RO; and
a module for operating an R4C according to the R4R item.

The present disclosure provides another terminal, including:
a module for receiving a hybrid RO from the RI server, with the existing right of the terminal and a newly added R4R carried in the hybrid RO;
a module for substituting the received hybrid RO for the existing RO; and a module for operating the R4C in the hybrid RO according to the new R4R.

The present disclosure accomplishes finer granularity for an RI to control the rights, intensifies the RI's control on the rights, meets the individualized requirements of the consumers to a greater extent, and improves their consumption experience. The present disclosure provides a mechanism of purchasing an R4R after the event. In this way, the consumers can decide whether to add a right of operating the right after purchasing an RO. When purchasing an RO initially, the consumers do not need to consider whether it is necessary to copy or move a right in the RO in the future, thus improving the consumption experience of the consumers greatly.

### BRIEF DESCRIPTION OF THE DRAWINGS

FIG. 1 shows the relations between RO4R, RO and DCF in an embodiment;

FIG. 2 shows the relation between a hybrid RO and a DCF in an embodiment;

FIG. 3 is a signaling flowchart of adding an R4R in an embodiment;

FIG. 4 is a signaling flowchart of the first method of upgrading an RO in an embodiment;

FIG. 5 is a signaling flowchart of the second method of upgrading an RO in an embodiment;

FIG. 6 is a signaling flowchart of the third method of upgrading an RO in an embodiment;

FIG. 7 is a signaling flowchart of the fourth method of upgrading an RO in an embodiment;

FIG. 8 simply shows the logical structure of a terminal for operating a Right for Contents (R4C) according an embodiment;

FIG. 9 simply shows the logical structure of a server for operating a Right for Contents (R4C) according an embodiment;

FIG. 10 simply shows the logical structure of a terminal for operating a Right for Contents (R4C) according an embodiment; and

FIG. 11 simply shows the logical structure of a terminal for operating a Right for Contents (R4C) according an embodiment of the present invention.

### DETAILED DESCRIPTION

The embodiments below are elaborated with reference to the accompanying drawings.

Right For Content (R4C), such as “play”, “print”, and “display”, is usage or activity allowed (by the Rights Issuer) over some media content. A Right Object (RO) for media contents contains one or more items of R4C. The operations that can be performed over such R4C items include: copy, move, and so on, which are called “operations over rights”. In order to control such operations, the information of rights for operation over right (R4R information) is needed for controlling the operations over the right items in the RO.

Each RO may include one or more R4C items. In order to refer to the R4C more conveniently in the previous operation right information, a unique identifier needs to be defined for each R4C (such as <play>, <print> and <display>) in the same RO so that the terminal can operate the corresponding R4C according to the R4R information. For example, the <play> right item may be expressed as:

<!ELEMENT o-dd:play (o-ex:constraint?)>
<!ATTLIST o-dd:play o-ex:id ID #REQUIRED>

The attribute “id” above is designed to uniquely identify a right item in an RO scope. Other right description elements such as <print> and <display> can be expressed similarly. In this way, the R4C identifier can be referred to conveniently in the R4R information to facilitate operations over an R4C.

Likewise, the information of rights for operation over right (R4R information) can be expressed as one or more R4R items. An R4R item contains an operation command, an operation object, and operation parameters. The operation command indicates the operations over rights such as “copy” and “move”; the operation object is any right item in the RO, or any combination of right items. If the operation object is empty, it indicates that the operation is effective on the whole RO. The operation parameters include: the right consumption status flag, target device information, and the target DRM system.

For example, the <copy> element that is used to express ‘copying rights is allowed’ can be described as:

<!ELEMENT copy(right_items?....)>
<!ELEMENT right_items (right_item+)>
<!ELEMENT right_item (#PCDATA)>

wherein,

<right_items> indicates the currently described the R4R item that can be copied(copy).

For certain R4C, the value of each <right_item> element corresponds to the identifier of an R4C. If the <right_items> element contains multiple <right_item> elements, it indicates that the currently described R4R item is effective on multiple R4C items such as copy (display, print). The elements such as <move> can be expressed as similar structures. If the <right_items> element does not occur in <copy> (namely, the operation object is empty), it indicates that the currently described R4R item is effective on the whole RO (copy the whole RO).

The right consumption status flag is designed to describe whether the operation is over the R4C only or over both R4C and the current consumption status of the R4C. Taking the copy operation as an example, the flag can clarify whether the current consumption status (the information like “the content has been consumed for 6 of 10 authorized times”) of the R4C item should be copied or not. For example, the aforementioned <right_item> element may include the following attribute:

<!ATTLIST right_item state_included (“yes”|“no”) “no”>

The value of this attribute is “yes” or “no”. Taking the copy operation as an example:

if the value of this attribute is set to “yes”, it indicates that: when copying an R4C item, the R4C item (including the information such as authorized number of times of consuming) and the current consumption status (the information like “the content has been consumed for 6 of 10 authorized times”) should be copied together to the destination;

if the value of this attribute is set to “no”, only the right item should be copied.

The target device information enables the RI server to control the devices involved in the operation for rights, for example, the target devices to which the R4C can be copied and moved. For example, the <copy> element may further include the following information:

<!ELEMENT copy(right_items?, to?....)>
<!ELEMENT to (deviceType*,deviceId*....)>
<!ELEMENT deviceType (#PCDATA)>
<!ELEMENT deviceId (#PCDATA)>

A <to > sub-element is added into the <copy> element to describe the destination of the copy operation. Generally, a <to > sub-element is the identifier of the target device type, or the identity of the target device, or the identifier of the target user such as WIM and IMSI. If no <to > sub-element occurs, the destination of the copy operation is not restricted. The <to > element contains a <deviceType> element and a <deviceId> element. These two elements may occur in the <to > element for any times, and are used for describing the information about the target device, for example, identifier of the device type. If a <to > element contains multiple <deviceType> elements, the copy operation can be performed onto multiple types of devices; if a <to > element contains multiple <deviceId> elements, the copy operation can be performed onto multiple specific devices. If neither <deviceType> element nor <deviceId> occurs, the destination of the copy operation is not restricted.

The target DRM system enables the RI server to control the target DRM systems involved in the operation for rights, for example, the target DRM systems to which the R4C can be copied and moved. For example, the <copy> element may further include the following information:

<!ELEMENT copy(right_items?, to?....)>
<!ELEMENT to (...dst_drm?)>
<!ELEMENT dst_drm(drm_id+)>
<!ELEMENT drm_id (#PCDATA)>

A <dst_drm> sub-element is added into the <to > element to describe the target DRM system of the copy operation. Generally, a <dst_drm> sub-element is the identifier of the target DRM system. If no <dst_drm> sub-element occurs, the target DRM system of the copy operation is not restricted. A <dst_drm> element may contain multiple <drm_id> elements. A <drm_id> element means that the right can be copied into multiple DRM systems.

The R4R information contains one or more R4R items mentioned above. Such R4R items can be combined into an independent RO, called “Right Object For Rights (RO4R)”; such R4R items together with the R4C can also be set as a part of an RO called “hybrid RO”. The two modes are described below.

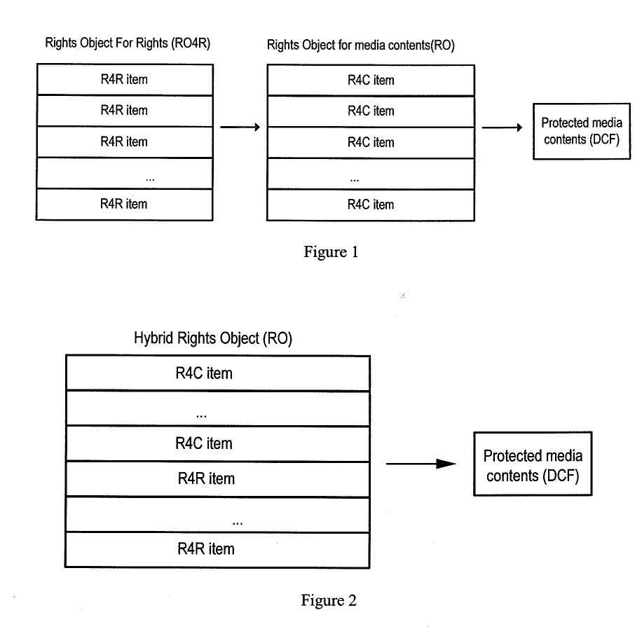

FIG. 1 shows the relations between RO4R, RO and DCF in the RO4R mode. The RO4R is a type of RO for controlling operations over the R4C or RO. The relation between an RO4R and an RO is similar to the relation between an RO and a protected media content—DRM Content Format (DCF). An RO contains at least one R4C; and an RO4R contains at least one R4R. According to the right item described in the RO, the DRM agent controls the application (such as player) to operate the DCF (for example, play the DCF). According to the operation right information described in the RO4R, the DRM agent controls the operations (such as copying and moving) over the RO or the right items in the RO.

The elements in an RO4R are:

<!ELEMENT right4rights (context, agreement)>
<!ATTLIST right4rights id ID #REQUIRED>
<!ELEMENT agreement(right_object, opera_control_info)>
<!ELEMENT right_object(context)>
<!ELEMENT opera_control_info(copy*,move*,split*,share*....)>

wherein,
the <right4rights> element is a root node of the RO4R, and contains two sub-elements:
<context> sub-element, designed to describe the information on the RO4R, such as unique identifier of the RO4R; and
<agreement> sub-element, designed to describe the R4R information;
the rights for an RO are described in the <agreement> sub-element;
the <right4rights> element contains an attribute ID, which serves as an auxiliary identifier for identifying an RO4R, wherein:
the <agreement> element contains two sub-elements:
<right_object> sub-element, designed to describe the information on the RO that can be operated, such as RO identifier; and
<opera_control_info> sub-element, designed to describe the operation rights for one or more R4C items in an RO described by the <right_object>.

As described above, an RO4R includes:
an RO4R identifier, designed to describe the information on the RO4R;
an RO identifier, designed to determine the RO for which the RO4R is intended; and
an R4R item, designed to describe the operating right for an RO or the operating right for the R4C items in the RO;
after obtaining the RO and the RO4R, the terminal operates the RO or the R4C in the RO according to the operation right information in the RO4R, such as copying, moving and so on.

FIG. 2 shows the relations between R4R, RO and DCF in the hybrid RO mode (namely, the R4R and the R4C are located together in the RO). An RO contains at least one R4C and at least one R4R. According to the R4C in the RO, the DRM agent controls the application (such as player) to operate the DCF (for example, play the DCF). According to the R4R described in the RO, the DRM agent controls the operations (such as copy and move) over the RO or the R4C. After the terminal obtains an RO that contains one or more R4R items, the terminal needs to search for the R4R items contained in the RO and execute the corresponding operation as controlled by the R4R, if the terminal needs to operate all or some of the R4C items in the RO.

If the R4R and the R4C are put into a hybrid RO, preferably, combined formally, namely, the R4R is not independent of the R4C but embedded in the R4C, it indicates that the terminal has a certain right for operating the R4C; and the R4C does not need to be identified uniquely any longer. For example, the syntax of an play right that can be operated may be expressed as:

<!ELEMENT o-dd:play (o-ex:constraint?, opera_control_info)>
<!ELEMENT opera_control_info(copy*,move*,split*,share*....)>
Given below is an example of three authorized times of playing:
<play>
<count>10</count> <!-The media content is allowed to be played
for 10 times-->
<move>3</move> <!-This play is allowed to be moved for
three times-->
</play>

The user or the terminal can request the RI server for the R4C and the R4R in a certain way in order to control the operations over media contents and the operations over rights. For example, the user can log in to the relevant website to operate on the web page and subscribe for the desired media contents; or subscribe for the R4C or R4R; the user can also use a terminal to originate a subscription request directly, and obtain R4C and R4R by sending a request message to the RI directly or through WAP or SMS. Such requests will finally arrive at the RI server.

After generating a hybrid RO, the RI can send it to the terminal. For example, after the RO request protocol (1-pass protocol and 2-pass protocol) is extended, the RO Response sent by the RI to the terminal may contain both R4C items and R4R items. For example, the RO Response may contain the following contents:

```
<move>
    <right_items>
        <right_item>xxxx</right_item>
    </right_items>
</move>
```

After receiving the R4R in the hybrid RO, the terminal obtains the right of operating the corresponding R4C, thus able to control the user to perform operations over rights.

After obtaining the RO or hybrid RO, the user can add more R4R items. The RI can combine the added R4R items into a separate RO4R or a new hybrid RO. The new hybrid RO contains the old RO and the newly added R4R. After receiving the new hybrid RO, the terminal substitutes it for the old RO.

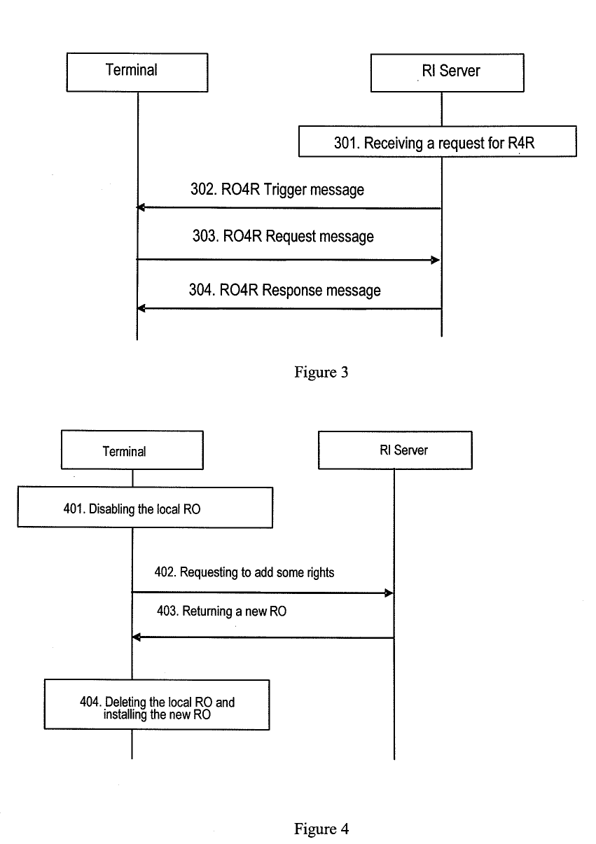

FIG. 3 is a signaling flowchart of adding R4R information in an embodiment. Taking the RO4R mode as an example, the flowchart includes the steps as described hereinafter.

Step 301: The terminal or the user requests the RI server for an R4R in a certain way. For example, the user logs into the relevant website and subscribes for an R4R on the web page. Such requests will finally arrive at the RI server. Such requests include these parameters:
information on the existing RO of the terminal, possibly including the current consumption status corresponding to the RO;
the right of operating the existing RO, which the user requests to add, for example, copying and moving; and possibly, the current consumption status corresponding to the RO.

The RI server obtains the existing RO of the terminal in two ways:
(i) the request message sent by the terminal includes the existing RO of the terminal; or
(ii) the request message sent by the terminal includes the identifier of the existing RO of the terminal; and the RI server stores the ROs that have been requested by the terminal, and obtains the existing RO of the terminal according to the received identifier of the RO.

Step 302: After receiving the request of obtaining an R4R, the RI server generates an RO4R according to the parameters therein, and then pushes an RO trigger message to the terminal, notifying the terminal that the existing RO4R is retrievable. The trigger message contains an RO4R identifier, and possibly contains the parameters shown in Table 1:

TABLE 1

| Message parameter | Meaning |
|---|---|
| Device ID | Identifier of the device |
| RI ID | Identifier of the RI |
| Device Nonce | One-off random quantity of devices |
| Request Time | Request time |
| RO4R Info | Information on the RO4R, for example, |
| | ID of the RO4R, ID of the corresponding |
| | RO. |
| Signature | Signature of the RI server |

Step 303: After obtaining the trigger message, the terminal obtains the ID of the RO4R, and generates and sends an RO request message that carries the ID of the RO4R to the RI server. Through this message, the terminal device requests the specific RO4R from the RI server. The request message may contain the parameters shown in Table 2:

TABLE 2

| Message parameter | Meaning |
|---|---|
| Device ID | Identifier of the device |
| RI ID | Identifier of the RI |
| Device Nonce | One-off random quantity of devices |
| Request Time | Request time |
| RO4R Info | Information on the RO4R, for |
| | example, ID of the RO4R. |
| Signature | Signature of the device |

Step 304: According to the RO identifier in the request message, the RI server finds the previously generated RO4R, generates an RO response that contains the RO4R, and then sends the RO response to the terminal. The terminal can retrieve the RO4R from the received response. In the process of retrieving the RO4R, the terminal device may authenticate the digital signature of the RO4R signed by the RI. If the authentication of the digital signature succeeds, the terminal may save this RO4R to the local directory so that it will be available when the RO for media contents is to be operated in the future. The terminal may read the R4R information in the RO4R directly without storing the RO, and operate the RO for media contents accordingly. If the digital signature authentication fails, the terminal will discard the RO4R. The RO4R response may contain the parameters shown in Table 3:

TABLE 3

| Message parameter | Meaning |
|---|---|
| Status | Indicates whether the RI responds |
| | to the RO4R Request message |
| | successfully |
| Device ID | Identifier of the device |
| RI ID | Identifier of the RI |
| Device Nonce | One-off random quantity of devices |
| Protected RO4Rs | Protected RO4R(s), which may |
| | follow the digital signature affixed |
| | by the RI for the RO4R. |
| Signature | Signature of the RI for this message |

If there are more than one protected RO4R in the previous message, every single RO4R follows the digital signature affixed by an RI for this RO4R; or multiple RO4Rs follow the general digital signature affixed by an RI for such RO4Rs.

In the previous steps, step 302 and step 303 may be omitted. That is, after generating the RO4R, the RI server generates an RO response directly and then sends the RO response to the terminal.

In the practical application, if the RI server knows that a terminal already owns an RO for media contents (for example, by recording the information on the RO purchased by the terminal) while the user does not purchase the right for operation for the RO, the RI server can push an RO response actively, without receiving any request from the terminal. Therefore, the terminal obtains an R4R. This is often a means for the RI to promote services.

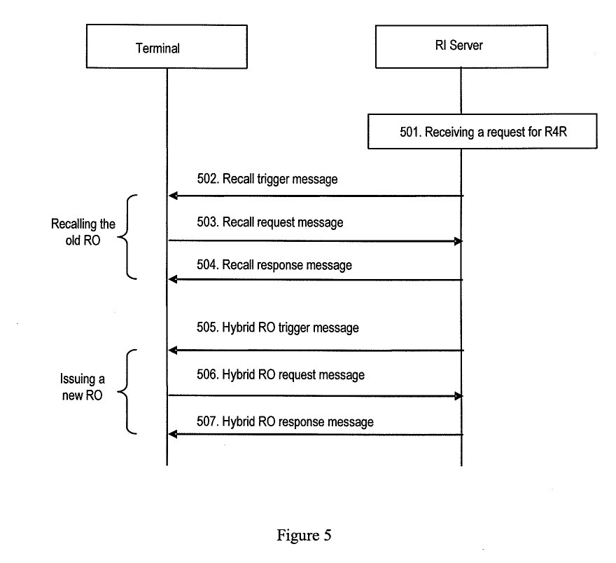

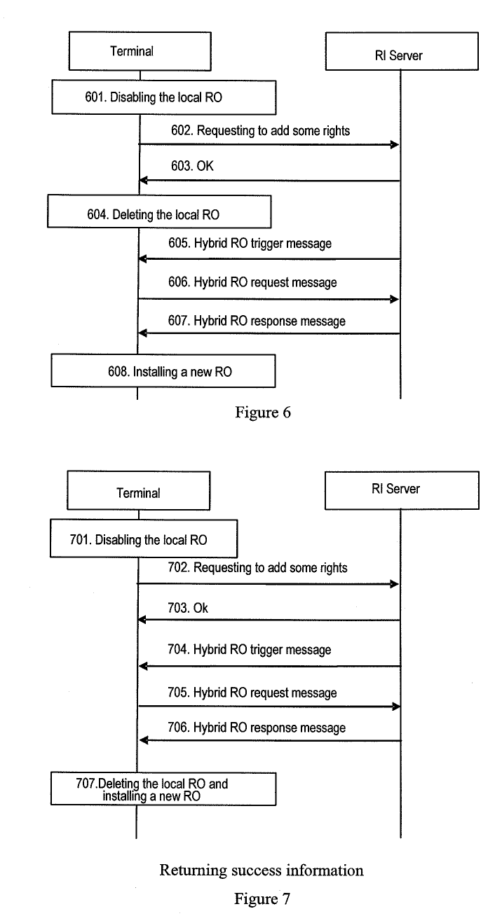

For the hybrid RO mode, the process of adding the R4R for an existing RO for media contents is different from the previous process, and this process is performed through RO upgrading. That is, an RO containing no desired R4R is upgraded to an RO containing the R4R, so that the terminal is allowed to operate the RO. More particularly, the processes shown in FIG. 4, FIG. 5, FIG. 6 or FIG. 7 may apply.

FIG. 4 is a flowchart of the first method of upgrading an RO in an embodiment. The procedure includes the steps as described hereinafter.

Step 401: The terminal sets the local RO, for which a right needs to be added, to the invalid status.

Step 402: The terminal requests the RI server to add a right to the RO. The request message carries the existing RO of the terminal and the right which the user requests to add. If the RI server stores the ROs that have been issued, the request message may carry the ID of the existing RO of the terminal; if the existing RO of the terminal is a stateful RO, the request message may also carry the current status information corresponding to the RO.

Step 403: The terminal receives a response from the RI server, with the new hybrid RO carried in the response. The new RO contains the existing rights of the terminal and the new R4R. The existing rights of the terminal come in two circumstances:
if the existing RO of the terminal mentioned in step 402 is a stateless RO (namely, the terminal does not need to maintain status information for the RO), the existing rights of the terminal will contain all the rights included in the existing RO of the terminal mentioned in step 402;
if the existing RO of the terminal mentioned in step 402 is a stateful RO (namely, the terminal needs to maintain status information for the RO), the existing rights of the terminal are a result of combining the existing RO of the terminal mentioned in step 402 and the current status information mentioned in step 402, as exemplified below:
the existing RO of the terminal includes the following rights:
<play><count>20</count></play>
the current status information is: “20 times in total, 5 times consumed by now”;
in this case, the “existing rights of the terminal” mentioned in step 403 are:
<play><count>15</count></play>

That is, the terminal holds the right of playing the content for 15 times.

Step 404: The terminal deletes the RO set to the invalid status, and then installs the received hybrid RO.

After setting the existing RO to the invalid status, the terminal receives a response from the RI server. If the response carries an error code, the terminal will reset the invalid RO to the valid status again.

The second method of upgrading an RO is:
after receiving a request of obtaining an R4R, the RI sends a recall trigger message to the terminal, thus triggering the process of taking back an existing RO of the terminal; and
the RI issues a new RO to the terminal in the way as illustrated in FIG. 4.

FIG. 5 is a flowchart of the second method of upgrading an RO in an embodiment. The flowchart includes the steps as described hereinafter.

Step 501: Like in step 301, the terminal or the user requests an R4R from the RI server in a certain way.

Step 502: After receiving the request for an R4R, the RI sends a recall trigger message to the terminal. The recall trigger message carries the ID of the RO of the R4R requested by the terminal.

Step 503: After receiving the recall trigger message, the terminal sends a recall request message to the RI. The message includes the RO mentioned in step 502. If the RO is stateful, the RO may contain the current consumption status of the RO. The terminal sets the local RO to the invalid status while sending the recall request message to the RI.

Step 504: After receiving the recall request, the RI sends a recall acknowledgement to the terminal; after receiving the recall acknowledgement, the terminal deletes the local RO.

The subsequent steps are similar to steps 302-304 (the RO4R is sent in steps 302-304, but the RO is sent the steps subsequent to step 504). The RI may send a new RO (hybrid RO) to the terminal directly; or the RI sends a trigger message first, and then the terminal retrieves the new RO from the RI, as shown in FIG. 5.

Step 505: The RI pushes a hybrid RO trigger message to the terminal, notifying the terminal that a hybrid RO is retrievable. The hybrid RO trigger message contains a hybrid RO identifier.

Step 506: After receiving the hybrid RO trigger message, the terminal sends a hybrid RO request message to the RI, with the ID of the new RO carried in the request.

Step 507: The RI sends a response to the terminal, with the new RO carried in the response. The RO contains not only the rights reflected by the previously deleted RO and its status information (if the RO is stateful), but also the rights which the user requests to operate.

FIG. 6 is a flowchart of the third method of upgrading an RO in an embodiment. The flowchart includes the steps as described hereinafter.

Step 601: The terminal sets the local RO, for which a right needs to be added, to the invalid status.

Step 602: The terminal requests the RI server to add a right. The request message carries the existing RO of the terminal and the RO which the user requests to add. If the RI server stores the ROs that have been issued, the request message may carry only the ID of the existing RO of the terminal; if the existing RO of the terminal is a stateful RO, the request message need also carry the current status information corresponding to the RO.

Step 603: The terminal receives a response returned by the RI server, with the response indicating whether the RI server accepts the request of the terminal.

Step 604: If the response in step 603 indicates that the IR accepts the request of the terminal, the terminal will delete the RO already set to the invalid status.

Step 605: The RI pushes a hybrid RO trigger message to the terminal, notifying the terminal that a hybrid RO is retrievable. The hybrid RO trigger message contains a hybrid RO identifier.

Step 606: After receiving the hybrid RO trigger message, the terminal sends a hybrid RO request message to the RI, with the ID of the new RO carried in the request.

Step 607: The RI sends a response to the terminal, with the new RO carried in the response. The RO contains not only the rights reflected by the previously deleted RO and its status information (if the RO is stateful), but also the rights which the user requests to operate.

Step 607: The terminal installs a new RO.

FIG. 7 is a flowchart of the fourth method of upgrading an RO in an embodiment. The flowchart includes the steps as described hereinafter.

Step 701: The terminal sets the local RO, for which a right needs to be added, to the invalid status.

Step 702: The terminal requests the RI server to add a right. The request message carries the existing RO of the terminal and the RO which the user requests to add. If the RI server stores the ROs that have been issued, the request message may carry only the ID of the existing RO of the terminal; if the existing RO of the terminal is a stateful RO, the request message need also carry the current status information corresponding to the RO.

Step 703: The terminal receives a response returned by the RI server, with the response indicating whether the RI server accepts the request of the terminal.

Step 704: The RI pushes a hybrid RO trigger message to the terminal, notifying the terminal that a hybrid RO is retrievable. The hybrid RO trigger message contains a hybrid RO identifier. Preferably, the trigger message also contains the ID of the existing RO mentioned in step 701 and step 702.

Step 705: After receiving the hybrid RO trigger message, the terminal sends a hybrid RO request message to the RI, with the ID of the new RO carried in the request.

Step 706: The RI sends a response to the terminal, with the new RO carried in the response. The RO contains not only the rights reflected by the previously deleted RO and its status information (if the RO is stateful), but also the rights which the user requests to operate. Preferably, if the trigger message in step 704 does not contain the identifier of the existing RO, the response should also contain the identifier of the existing RO mentioned in step 701 and step 702.

Step 707: The terminal deletes the existing RO mentioned in step 701 and step 702, and installs the new RO mentioned in step 706.

The embodiments of the present invention also cover the terminals or servers described below.

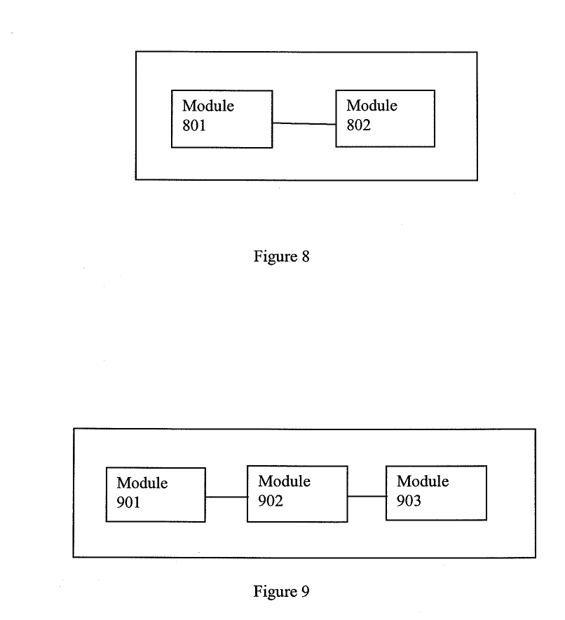

As shown in FIG. 8, a terminal includes:
a module (801), adapted to obtain a hybrid RO generated by the RI server, wherein the hybrid RO contains R4C items and R4Rs; and
a module (802), adapted to operate an R4C item in the hybrid RO according to the R4R.

As shown in the FIG. 9, a server includes:
a module (901), adapted to obtain the existing RO of a terminal, with an R4C carried in the RO;
a module (902), adapted to generate the R4R information which indicates that the terminal is entitled to operate the R4C; and
a module (903), adapted to send the R4R information to the terminal.

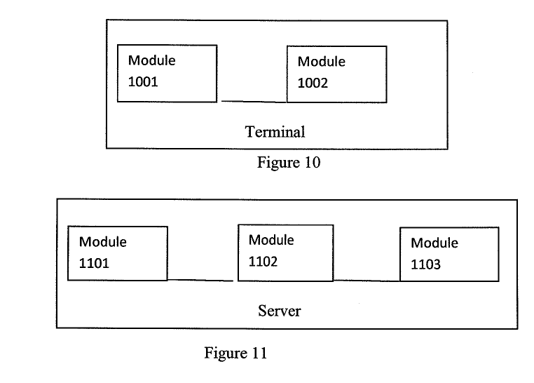

As shown in the FIG. 10, another terminal includes:
a module (1001), adapted to receive an RO4R from the RI server, with an R4R item carried in the RO; and
a module (1002), adapted to operate an R4C according to the R4R item.

As shown in the FIG. 11, another terminal includes:
a module (1101), adapted to receive a hybrid RO from the RI server, with the existing right of the terminal and a newly added R4R carried in the hybrid RO;
a module (1102), adapted to substitute the received hybrid RO for the existing RO; and
a module (1103), adapted to operate the R4C in the hybrid RO according to the new R4R.

Although the some exemplary embodiments are disclosed above, the claims are not limited to such embodiments. It is apparent that those skilled in the art can make various modifications and variations to the embodiments without departing from the spirit and scope of the claims. The claims are intended to cover these modifications and variations.

What is claimed is:

1. A method for operating a Right For Content (R4C) in a digital rights management environment, comprising:
obtaining, by a terminal, a hybrid Right Object (RO), generated by a Rights Issuer (RI) server, that includes at least one item of R4C and at least one item of Right For Rights (R4R); and
operating, by a terminal, according to said R4R, over said R4C item in said hybrid RO.

2. The method of claim 1, wherein said R4C item has a unique identifier, and said R4R item includes an identifier of said R4C item on which said R4R is effective.

3. The method of claim 1, wherein said R4C item includes said R4R that indicates said right of operating over said R4C.

4. The method of claim 2 or 3, wherein said R4R further includes at least one: a right consumption status flag, target device information, and a target DRM system identifier.

5. The method of claim 2, wherein operations over said R4C item in said hybrid RO include at least one of: between moving and copying.

6. A method for adding a right in a digital rights management environment, comprising:
obtaining, by a Right issuer (RI) server, an existing Right Object (RO) owned by a terminal, said existing RO containing at least one Right For Content (R4C) item;
generating, by said Right issuer (RI) server, a Right For Rights (R4R) information, said R4R information containing at least one item of R4R, each one of which indicates that said terminal is allowed to operate over at least one of said R4C; and
sending, by a Right issuer (RI) server, said R4R information to said terminal.

7. The method of claim 6, wherein said R4R information is a Right Object for Rights (RO4R) containing at least one item of R4R.

8. The method of claim 7, further comprising:
sending, by said RI server, a trigger message to said terminal before sending said RO4R to said terminal; said trigger message including an identifier of said RO4R; and
wherein sending said RO4R to said terminal includes:
sending a response message carrying said RO4R to said terminal when said RI server receives from said terminal a request message generated by said terminal according to said trigger message.

9. The method of claim 8, wherein said RO4R includes an identifier of said existing RO.

10. The method of claim 9, wherein said RO4R includes the identifier of said right items in said existing RO.

11. The method of claim 6, wherein said R4R information is a hybrid RO which includes existing rights in said existing RO and at least one newly added R4R.

12. The method of claim 11, further comprising:
sending, by said RI server, a recall trigger message to said terminal before sending said hybrid RO to said terminal; said trigger message including an identifier of said existing RO; and
wherein sending said hybrid RO to said terminal includes:
sending an acknowledgement message carrying said identifier of said existing RO to said terminal when said RI server receives said recall request message generated according to said recall trigger message from said terminal.

13. The method of claim 6, wherein obtaining said existing RO includes at least one of:
obtaining said existing RO from a request message, sent by said terminal, the request message including said existing RO; and
receiving said request message, sent by said terminal, which includes an identifier of said existing RO; and then obtaining said existing RO by searching for ROs stored in the RI server by said identifier of said existing RO.

14. The method of claim 13, wherein:
said request message further includes at least one operation right requested to be added by a user; and
wherein said generated R4R information includes the operation right requested to be added by said user.

15. A method for adding a right in a digital rights management environment, comprising:
receiving, by a terminal, a Right Object for Rights (RO4R) that includes at least one R4R from a Right Issuer (RI) server; and
operating, by said terminal, over at least one item of Right for Content (R4C) in an existing RO owned by said terminal according to said R4R.

16. The method of claim 15, further comprising:
receiving, before receiving the RO4R, by said terminal, a trigger message carrying an identifier of said RO4R from said RI server; and
generating a request message according to said trigger message and sending said request message to said RI server.

17. The method of claim 15, wherein operating over said R4C according to said R4R includes at least one of:
operating over said R4C directly; and
saving said RO4R and operating over said R4C according to said saved RO4R.

18. The method of claim 17, further comprising:
sending, before receiving said RO4R, a request of adding said R4R to said RI server, wherein said request of adding said R4R carries at least one of: said existing RO, said identifier of said existing RO, and status information of said existing RO if said existing RO is stateful.

19. The method of claim 18, wherein the request of adding an R4R sent by the terminal further comprises said R4R to be added.

20. A method for adding a right in a digital rights management environment, comprising:
receiving, by a terminal, a hybrid Right Object (RO) from a Right Issuer (RI) server, wherein said hybrid RO carries existing rights in an existing RO in said terminal and newly added R4R;
substituting said hybrid RO for said existing RO; and
operating Right For Content (R4C) in said hybrid RO according to said newly added R4R.

21. The method of claim 20, further comprising:
receiving, before receiving said hybrid RO, a trigger message from said RI server, said trigger message carrying an identifier of said hybrid RO; and
generating a request message according to said trigger message and sending said request message to said RI server.

22. The method of claim 20, further comprising:
requesting, before receiving said hybrid RO, an RO from said RI server, wherein said request for the RO carries at least one of: said existing RO, an identifier of said existing RO, and status information of said existing RO if said existing RO is stateful.

23. The method of claim 21, farther comprising:
disabling said existing RO.

24. The method of claim 23, further comprising:
receiving a response message that includes said hybrid RO and is sent from said RI server; and
deleting said disabled existing RO, and installing said hybrid RO.

25. The method of claim 23, further comprising:
receiving a response that includes an error code, the error code having been sent from said RI server; and
resetting said existing RO from an invalid status, to a valid status.

26. The method of claim 20, further comprising:
receiving a recall acknowledgement that carries an identifier of said existing RO recall; and
deleting said existing RO according to said identifier of said existing RO.

27. The method of claim 26, further comprising:
receiving, before receiving the recall acknowledgement, a recall trigger message that carries said identifier of said existing RO recall;
disabling said existing RO according to the recall trigger message; and
generating a recall request and sending it to the RI server.

28. The method of claim 26, further comprising:
receiving, before receiving the recall acknowledgement, a recall trigger message that carries said identifier of said existing RO recall;
deleting said existing RO according to the recall trigger message; and
generating a recall request and sending it to the RI server.

29. A terminal for operating a Right For Content (R4C), comprising:
a module, adapted to obtain a hybrid Right Object (RO) that includes at least one of R4C item and at least one of R4R and is generated by a Right Issuer (RI) server; and
a module, adapted to operate said R4C items in said hybrid RO according to the R4R.

30. A server for operating a Right For Content (R4C), comprising:
a module, adapted to obtain an existing RO of a terminal, with said R4C carried in said RO;
a module, adapted to generate Right for Rights (R4R) information that indicates that said terminal is entitled to operate said R4C; and
a module, adapted to send said R4R information to said terminal.

31. A terminal for operating a Right For Content (R4C), comprising:
a module, adapted to receive an RO4R that includes Right for Rights (R4R) items from a Right Issuer (RI) server; and
a module, adapted to operate said R4C according to said R4R items.

32. A terminal for operating a Right For Content (R4C), comprising:
a module, adapted to receive a hybrid RO from a Right Issue (RI) server, with said hybrid RO carrying existing rights of said terminal and newly added Right for Rights (R4R);
a module, adapted to substitute said received hybrid RO for existing RO; and
a module, adapted to operate said R4C in said hybrid RO according to said newly added R4R.

33. One or more computer readable media, comprising logic encoded in the computer readable media for operating a Right For Content (R4C) in a digital rights management environment, the logic when executed by a machine is operable to cause the machine to perform acts of:
obtaining, by a terminal, a hybrid Right Object (RO), generated by a Rights Issuer (RI) server, that includes at least one item of R4C and at least one item of Right For Rights (R4R); and
operating, by a terminal, according to said R4R, over said R4C item in said hybrid RO.

34. One or more computer readable media, comprising logic encoded in the computer readable media for adding a right in a digital rights management environment, the logic when executed by a machine is operable to cause a machine to perform acts of:
receiving, by a terminal, a Right Object for Rights (RO4R) that includes at least one R4R from a Right Issuer (RI) server; and
operating, by said terminal, over at least one item of Right for Content (R4C) in an existing RO owned by said terminal according to said R4R.

35. One or more computer readable media, comprising logic encoded in the computer readable media for adding a right in a digital rights management environment, the logic when executed by a machine is operable to cause a machine to perform acts of:
receiving, by a terminal, a hybrid Right Object (RO) from a Right Issuer (RI) server, wherein said hybrid RO carries existing rights in an existing RO in said terminal and newly added R4R;
substituting said hybrid RO for said existing RO; and
operating Right For Content (R4C) in said hybrid RO according to said newly added R4R.
